(19) United States
(12) Patent Application Publication
(10) Pub. No.: US 2012/0030557 A1
(43) Pub. Date: Feb. 2, 2012

(54) METHOD AND APPARATUS OF ACCESSING AND MODIFYING THE CONTENT OF AN ELECTRONIC DATA FORM

(76) Inventor: Brian David Wiblin, Dallas, TX (US)

(21) Appl. No.: 13/193,595

(22) Filed: Jul. 28, 2011

Related U.S. Application Data
(60) Provisional application No. 61/368,347, filed on Jul. 28, 2010.
(60) Provisional application No. 61/368,811, filed on Jul. 29, 2010.

(51) Int. Cl. G06F 17/27

(52) U.S. Cl. 715/226

(57) ABSTRACT

Example embodiments of the present invention may include a method that includes receiving values entered corresponding to a data form and providing interactive text boxes to a transparent layer that overlays the data form. The method may also include automatically entering the received values as data input entries into the text boxes of the transparent layer and transmitting the received values to a database.

### CROSS REFERENCE TO RELATED APPLICATIONS

This application claims benefit to provisional application No. 61/368,347, entitled “DEVICE AND PROCESS TO COLLECT AND STORE DATA”, filed on Jul. 28, 2010 and provisional application No. 61/368,811, entitled “DEVICE AND PROCESS TO COLLECT AND STORE DATA”, filed on Jul. 29, 2010, the entire contents of each are hereby incorporated by reference.

### TECHNICAL FIELD OF THE INVENTION

This invention relates to modifying and creating data forms, and more particularly, to providing a dynamic form that may be seamlessly modified by a user to include new content of form data fields.

### BACKGROUND OF THE INVENTION

Creating data forms can be arduous and time consuming. For example, when adding text boxes to a form and fields to a database each addition requires one or more parameters to be selected prior to entering the new item to the data form and linking it to the database. For each interactive text box that is added to a data form, the user must specify the location, size, and name of the text box. For example, a “first name” text box could be 4″ from the top and 3″ from the right and could be 0.25″ high and 0.75″ long. Additionally, if the data is saved in a database, the field must be created in the database, and the interactive text box must be mapped to a field in a database.

### SUMMARY OF THE INVENTION

An example embodiment may provide a method that includes receiving values entered corresponding to a data form, providing interactive text boxes to a transparent layer that overlays the data form, automatically entering the received values as data input entries into the text boxes of the transparent layer, and transmitting the received values to a database.

Another example embodiment of the present invention may include an apparatus including a receiver configured to receive values entered corresponding to a data form, a processor configured to provide interactive text boxes to a transparent layer that overlays the data form and automatically enter the received values as data input entries into the text boxes of the transparent layer, and a transmitter configured to transmit the received values to a database.

### BRIEF DESCRIPTION OF THE DRAWINGS

FIG. 1 illustrates an example network configuration according to example embodiments of the present invention.

FIG. 2A illustrates a user display providing access to a data form according to example embodiments of the present invention.

FIG. 2B illustrates an example of multiple users entering data into the data form and a corresponding data export operation according to example embodiments of the present invention.

FIG. 3 illustrates an example of embedded code used in accordance with a data form according to example embodiments of the present invention.

FIG. 4 illustrates an example of an embedded code used in accordance with a website form according to example embodiments of the present invention.

FIG. 5 illustrates an example of exported data extracted from a data form according to example embodiments of the present invention.

FIG. 6 illustrates an example system diagram used to process a form document.

FIG. 7 illustrates a network entity that may include memory, software code and other computer processing hardware, and which may be configured to perform operations according to example embodiments of the present invention.

FIG. 8 illustrates a flow diagram of an example method of operation according to example embodiments of the present invention.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

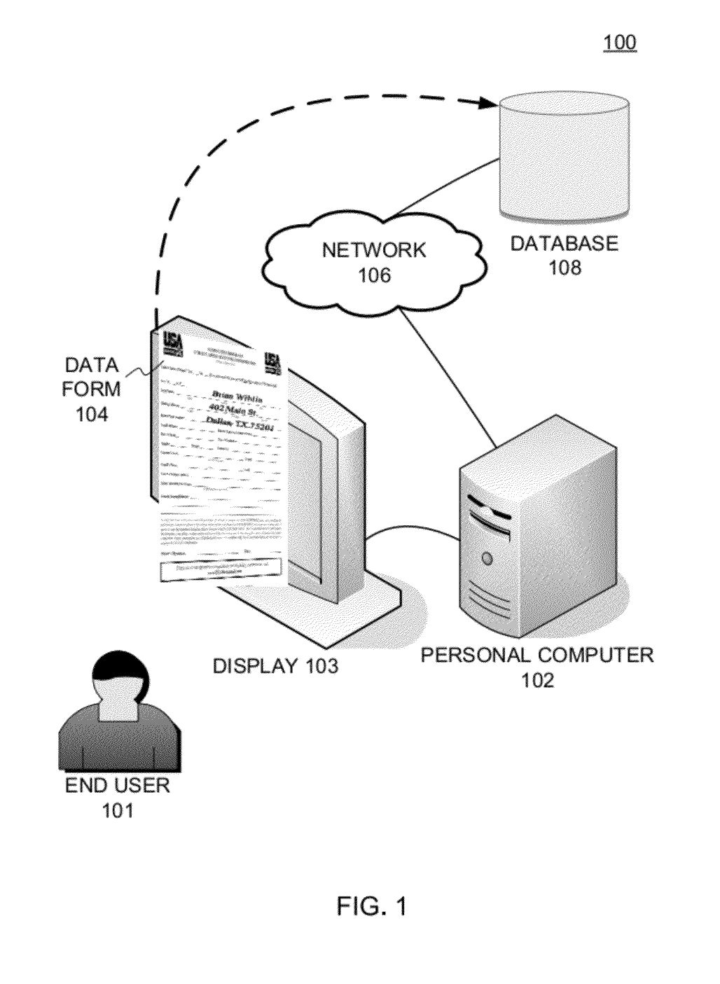

FIG. 1 illustrates an example network according to example embodiments. Referring to FIG. 1, a communication network 100 includes an end user 101 accessing a data form 104 viewable on a display of a personal computer 103. The data form may be accessible via any computing device (e.g., a smartphone, personal digital assistant (PDA), tablet computing device, laptop computer, etc.). The user may enter his or her information into the data form 104 as a prerequisite to receiving access to a new service, a new job, etc. The data form may be an electronic form that accepts user input via typed responses, voice recognition or any other digital data input configuration.

The data form 104 may be filled-out by the user 101 and submitted via his or her computer over a network 106, such as the Internet to a database which stores the data entries and the form for access via a third party entity seeking access to the user information. The data form 104 may include an invisible data layer that the user does not see when accessing the data form 104. The form may have multiple layers that are created for multiple different users who access the data form 104 at different times.

With regard to the examples described throughout the specification, certain terms may be defined as follows. A data entry area may be the area on the display screen that the user views the form and types in the form. The area includes a form layer and/or a data layer. A form layer is an image of a form. A data layer is a transparent area onto which the user types values, otherwise referred to as a transparent overlay. An interactive text box is a part of the form that enables data to be entered and saved within the form. Values may include data typed onto the data layer or into an interactive text box. Fields may include a group of values or an individual piece of standardized data (e.g. first name, last name, area code, phone number, etc.). Columns may include columns in a spreadsheet, which are a list of the values entered in a particular field. A computing device may be any device that acts as a computer regardless of a size or mobility, and may include mainframes, servers, desktop computers, laptops, tablets, and mobile phones. An electronic form may be a form presented to and filled out by a user on a computing device. A paper form may be a form presented to and filled out by a user on paper either with handwriting or with a typewriter.

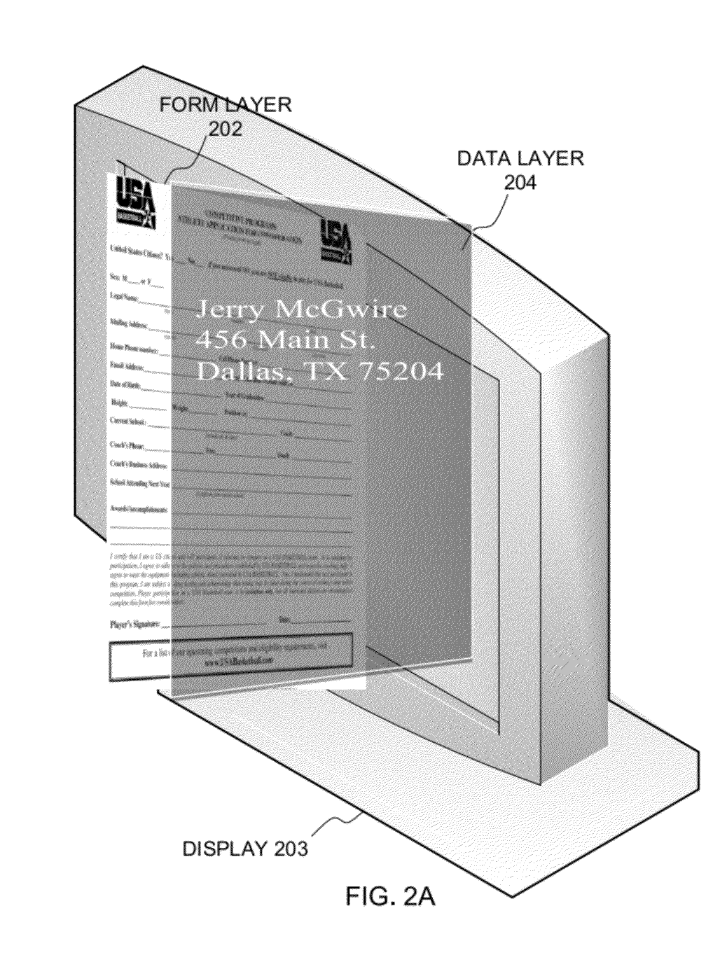

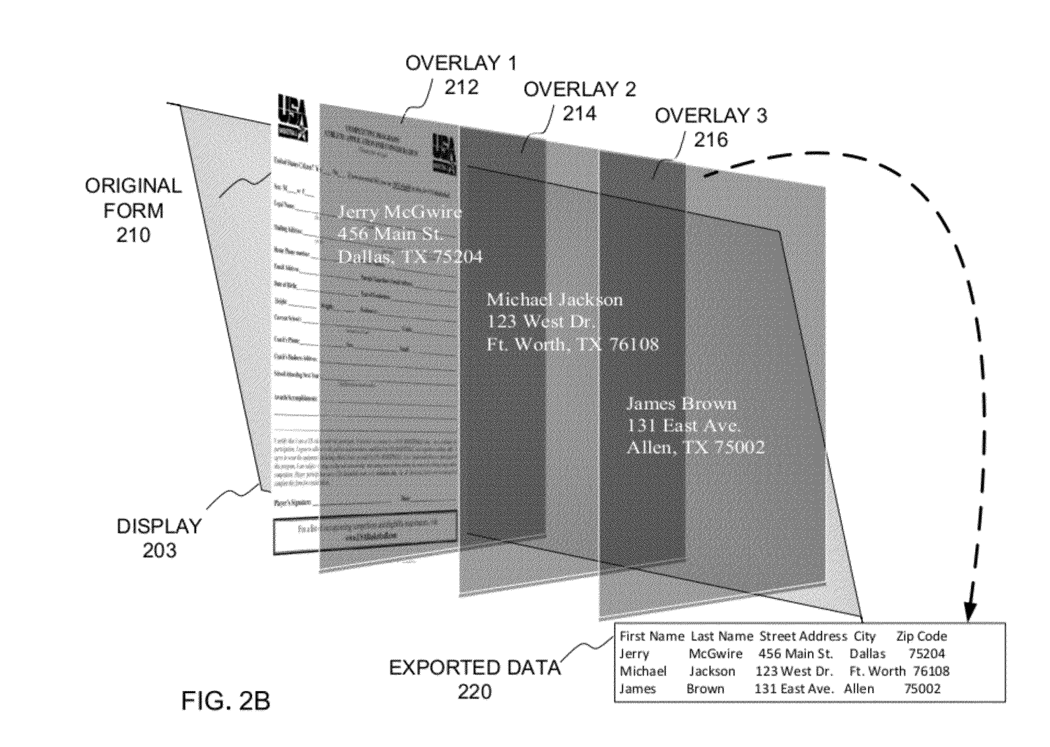

Referring to FIG. 2A, a data form may include a form layer 202 and a data layer 204. The data form may be presented to the user on his or her display monitor 203. In operation, the user may access the data form and begin entering information on the form layer 202. In the background, a separate data layer 204 may represent an invisible layer that corresponds to the user session. For instance, the user may enter information into the form and trigger the creation of a separate document for the data layer 204 that is based on the original form layer 202.

Example embodiments may enable the end user to automatically add interactive text boxes to forms to modify an existing form. For example, by typing data into an overlay that is transparent and invisible or semi-transparent and viewable to the user, and that appears to lay on top of the form. Additionally, the interactive text boxes may be automatically populated with data that was typed on the form before the text box was added.

Example embodiments of the present invention provide saving data storage space by separating the form layer and the data layer. When data is stored inside the form, the non-data part of the form must be saved each time the form is saved. However, this allows the data to be saved just one time as opposed to many times, regardless of how many times the form is filled out.

Referring to FIG. 2A, in operation, the user 101 may observe a data entry area, which is comprised of a form layer 202 and a data layer 204. The transparent data layer 204 is laid on top of the form layer 202. To the user, who does not see the transparent data layer 204, it appears as though they are typing on the form. However, according to the composition and backend arrangement of the data form, the user is actually typing on a data layer on top of the original electronic form. In another example, the user 101 could be alerted to the fact they are typing on a data layer by presenting an icon, pop-up window, or other type of message to inform the user of the added data layer plug-in.

When the user is typing or providing data entries onto the data layer 204, the corresponding information is recorded in the database 108 (see FIG. 1). The database 108 may create a new content file to store the attributes of the data form. The attributes may be new attributes or modified pre-existing attributes (e.g., text, images, data entry fields, links to data sources, etc.). The database 108 may also store the value content (what was typed), characteristics of the value content, (e.g. font and formatting), the value form location (where is the typing placed on the form page), for example, 3″ from the top and 5″ from the left.

A new data form layer may be created when a new form is created. There is generally only one form layer for each form created. Each time a particular data form is filled-out, the form layer is reused. However, each time a data form is filled-out, a new data layer is created and associated with that form layer. New data layers may be created for each user initiated access operation. For example, each time a user begins filling-out the form, the form layer is presented to the user to guide the entries submitted by the user. However, for each new user name, form initiation procedure and/or combination of filled-out form data, a new data layer may be created to uniquely identify the form filling instance currently being conducted.

According to one example, a corresponding form application may be used to analyze values typed on the data layer 204. Interactive text fields may be automatically added to the data layer 204. The database 108 may be configured to retrieve values that have already been saved in the database 108 or other storage device and automatically submit or enter those values onto the data layer 204. The data may have been previously saved by another user or computer application.

In another example, values may be assigned to fields based on the coordinates of values in other forms. For example, a data field of “First Name” may be in approximately the same location on each data layer by each user of the data form, because they are using the same form layer as a guide. As a visual example, if you stacked the data layers on top of each other then you would see the values typed for “First Name” stacked approximately at the same form location directly on top of each other. This allows the data that is entered into the forms to be exported into organized columns. Each location on the page is assigned to its own column.

FIG. 2B illustrates an example of multiple users entering data into the data form and a corresponding data export operation according to example embodiments of the present invention. Referring to FIG. 2B, an original form 210 may be viewed by a user on a display device 203. The first user may access the form and trigger the creation of a unique overlay 1 (212) to be created. The user may begin entering personal information such as, user name, address, etc., into the overlay 1 without knowing that the form data is being intercepted by the overlay 1 (212). The data may be transferred to a backend application that creates a file corresponding to the entered data and stored the data file for future reference.

As more users begin using the form, additional overlays 2 (214) and 3 (216) may be created to correspond to users 2 and 3 of the original form 210. The user inputted information may be extracted from the overlays and tallied into a column and row format in a spreadsheet file stored in the database 108. The exported data 220 may be organized after a predetermined number of users access the original form 210 and a number of overlays have been created. Any changes to the information may be automatically updated when the user accesses the form at a later time and makes changes or modifications to the previously submitted information.

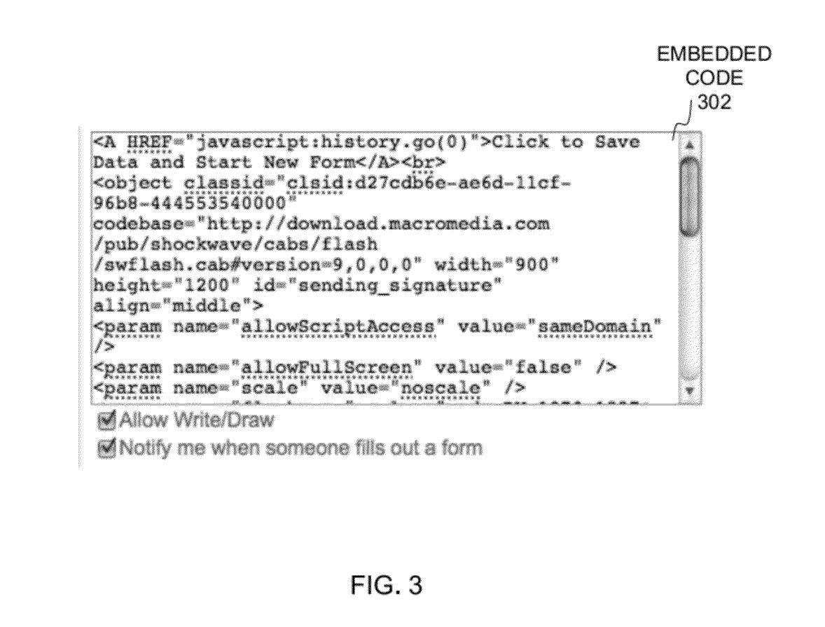

FIG. 3 illustrates an example of embedded code used in accordance with a data form according to example embodiments of the present invention. Referring to FIG. 3, the form may be created and placed on a website or reference location. The data used to initiate the creation of such a form is illustrated as the embedded code 302 of FIG. 3. The embedded code may be easily incorporated into website code as an add-on or plug-in for a particular page. The data received by users of the webpage may be transmitted to remote storage locations as specified by the embedded code 302.

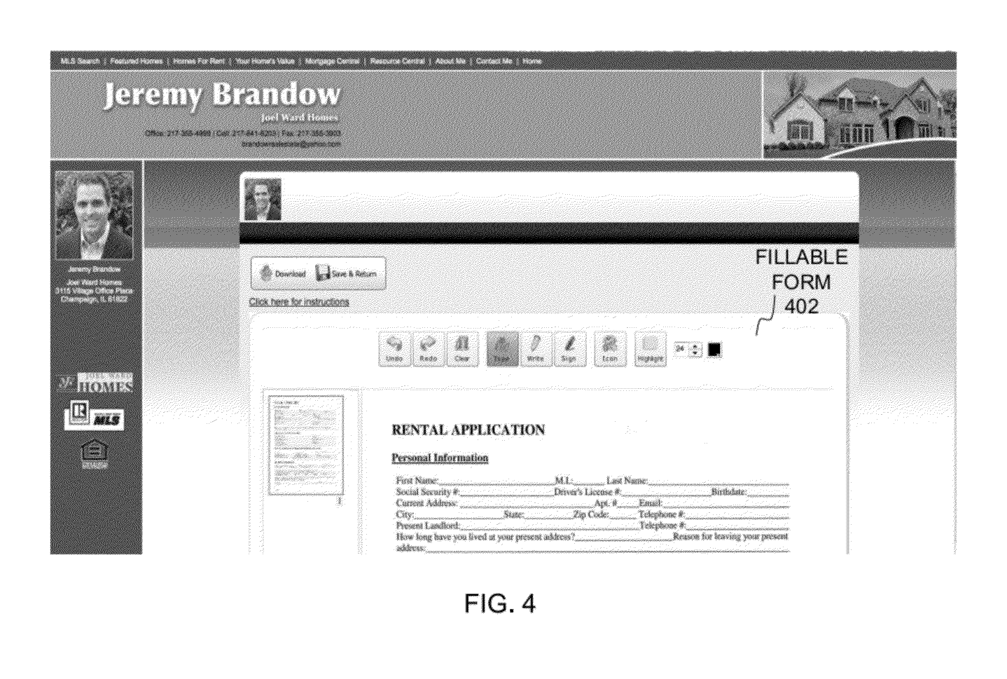

FIG. 4 illustrates an example of embedded code used in accordance with a website form according to example embodiments of the present invention. Referring to FIG. 4, a webpage is illustrated as having a real estate agent and corresponding information. A fillable form 402 may be inserted into the webpage to offer an add-on feature for users to access a data form that is related to the content of the website. This provides a fast and easy way to reliably create data forms that are configured to expedite the data received from multiple users who accessed and filled-out the data form 402.

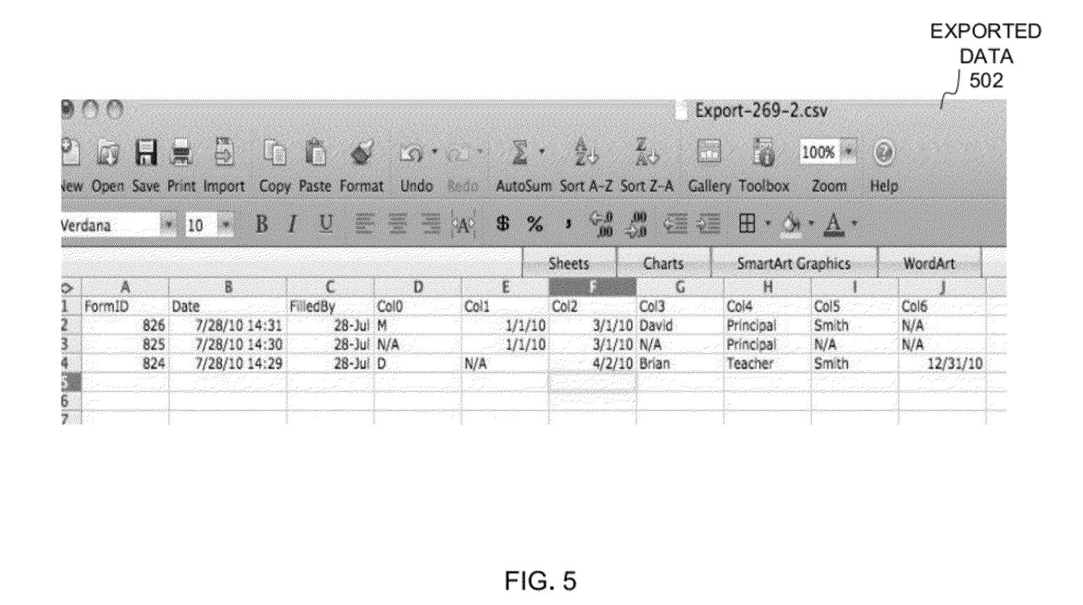

FIG. 5 illustrates an example of exported data extracted from a data form according to example embodiments of the present invention. Referring to FIG. 5, the data that is extracted from a corresponding data form, its various form layers and created data overlays may be organized into columns and rows and saved in a spreadsheet format. The exported data 502 may be saved in a specific file format and may be cataloged according to file naming convention. FIG. 5 illustrates a list of form attributes that were captured based on user interactions with the forms. Various data may be automatically generated, such as the time of day, form ID, date, etc. Other fields may be form-specific and may export data entered by the users who interact with the form.

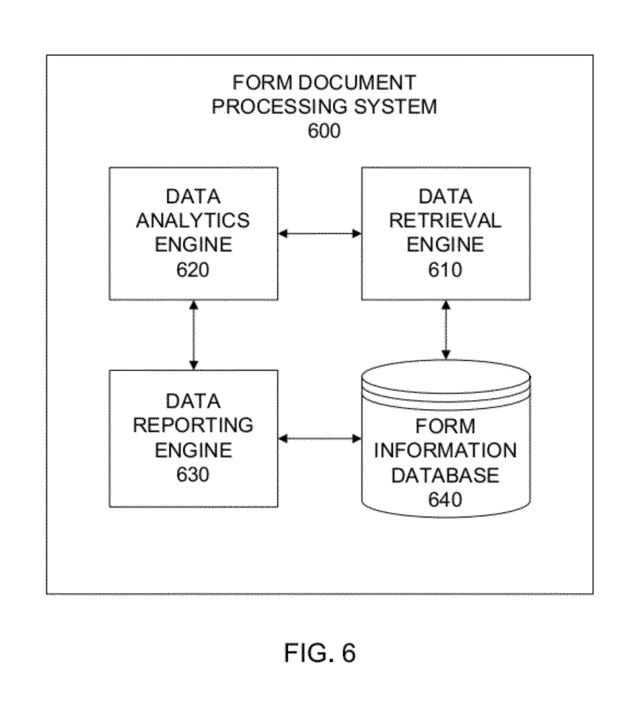

FIG. 6 illustrates an example system diagram used to process a form document. Referring to FIG. 6, the form document processing system may be a computer, server of processing device that is configured to process form data by using various engines and data storage devices. The engines may be based on the operation performed by one or more processors and the database may be based on one or more memory storage locations.

According to one example, a user may provide data entry values into a transparent data layer of a data form using the image of a form underneath as a guide for entering the values. The data retrieval engine 610 may accept the information and store the data in a form information database 640. Once the user begins entering data into the form, the overlay may automatically incorporate interactive text boxes and other form related attributes based on where the user submits data to the form. The automatic response may be provided based on feedback from the user and the responses generated by the data analytics engine 620. As a result, certain data may be provided automatically into the interactive text boxes based on past responses, most common responses, or other criteria.

The data analytics engine 620 may also automatically add fields to a database spreadsheet file and name the fields based on the coordinates of the values typed relative to the coordinates of the text in the form layer with respect to the coordinate positions of the text boxes as compared to the original form. For example, the user may dynamically alter the form by entering data into the data layer (overlay) that is not part of the original form layer. The values entered in the interactive text boxes may be automatically validated based on the field names, and the corresponding data entered may be extracted and stored via a data reporting engine 630.

According to another example, certain data may have been already saved in the database 640 or computer and retrieved, and those values of the retrieved data are automatically typed or entered into the interactive text boxes. The data may have previously been saved by another user or computer application. The forms that are filled-out may be saved as one document and the data entered may be extracted and saved as values in a separate document or part of document that stores multiple results provided by multiple different users and extracted from the same document.

The text entries may be examined and compared to determine whether the value was intentionally avoided. For example, if User_{—}2 skipped the entry for “Middle_Name”, then, the process will assign a “Null” value to Middle_Name for that data layer. Each field may be exported to a corresponding column. It may be automatically determined which values belong to which fields, by locating values that are in the exact location or approximately the same location and assigning them to the same field.

According to another example embodiment, computer generated instructions may be used to pair values with particular fields. For example,

{0—Define the variable “Fields” as a 2 dimensional array (layer, value)

1—set r=15 (search radius measured in pixels)

2—set n=0 (layer counter)

3—set v=0 (value counter)

4—set n=n+1

5—set v=v+1

6—search layer(n) starting on top row of pixels left to right until a value is found

7—set n=n+1

8—set v=v+1

9—search layer(n) starting on top row of pixels left to right until a value is found

10—if ((x_n−x_n−1)+(y_n−y_n−1))̂0.5<=(sr) then Field(1,1)=Value(1) and Field (2,1)=Value(2)

11 if n=n(max) (yes goto 5) (else end)}, [where r=radius, n=layer counter, v=value counter].

In another example, the following code “Docs” represents forms, “Pages” represents forms, and “Labels” represents values. This example embodiment may provide a way to automatically determine which values belong to which fields.

The code/algorithm may proceed by creating template T to be equal to the first document,

{FOR ALL Docs (d) THEN
FOR ALL Pages (p) on (d)
FOR ALL Labels (l) on (p)
DO
x = find all labels near first label on template
if (x is something) THEN remove all those labels
else ADD labels to template T
END}.

Then sort by x (coordinate), then by y (coordinate) through all documents and create the results based on the template T.

Any of the above forms and related features can be performed on a remote website by embedding the above-examples of code in the html of the website. One example code used to embed a fillable form in a third party website provides:

```
<A HREF=“javascript:history.go(0)”>Click to Save Data and Start
New Form</A><br><object classid=“clsid:d27cdb6e-ae6d-11cf-96b8-
444553540000”codebase=“http://download.macromedia.com/pub/
shockwave/cabs/flash/swflash.cab#version=9,0,0,0”width=
“900”height=“1200” id=“sending_signature” align=“middle”>
    <param name=“allowScriptAccess” value=“sameDomain” />
    <param name=“allowFullScreen” value=“false” />
    <param name=“scale” value=“noscale” />
    <param name=“flashvars” value=“code=BW-
1070.1837&URLPrefix=http%3a%2f%2ffapbeta.fillanypdf.com%2f” />
```

| | |
|---|---|
| <param | name=“movie” |

```
value=“http://fapbeta.fillanypdf.com/sending_signature.swf” />
    <param name=“quality” value=“high” />
    <param name=“bgcolor” value=“#ffffff” />
    <embed
src=“http://fapbeta.fillanypdf.com/sending_signature.swf”
flashvars=“code=BW-
1070.1837&URLPrefix=http%3a%2f%2ffapbeta.fillanypdf.com%2f”
quality=“high” bgcolor=“#ffffff” scale=“noscale” width=“900”
height=“1200” name=“sending_signature” align=“middle”
allowscriptaccess=“sameDomain” allowfullscreen=“false”
type=“application/x-shockwave-flash”
pluginspage=“http://www.macromedia.com/go/getflashplayer” />
</object>.
```

Other example embodiments may include various parameters used to identify and define the layout of the data form for additional data form modifications and accessibility. Some definitions used to describe the data form may include: SD=sensitivity distance, Xmax=a coordinate furthest from 0 in the x direction, Ymax a coordinate furthest from 0 in the y direction, MaxDist=a greater of Xmax and Ymax, NumValuesTyped=a number of values typed on all overlays, NumFieldsActual=Round(NumValuesTyped/NumOverlays), NumFieldsActual (alternate)=value entered by a user, NumOverlays=number of overlays on which values have been typed, ValueTyped=anything typed by the user, ValueTypedLocation(X)=x coordinate of a typed value, ValueTypedLocation(Y)=y coordinate of a typed value. According to one example, the coordinate is the top left corner of the value entered. Additional values may include: Field(Overlay,FieldNumber)=the value typed that belongs to a particular field number on an overlay.

Example embodiments of the present invention may required users to fill out a form by typing on a transparent overlay. Then, the values entered by the user, and the location of those values entered on the plane of the form may be used as input for additional processing measures. For example, a process to automatically calculate the “sensitivity distance” is shown below:

```
    For SD = 1 to MaxDist
        For x = 0 to Xmax
            For y = 0 to Ymax
                For Overlay = 1 to NumOverlays
                    For ValueTyped = 1 to MaxOnOverlay
    If (x − SD) <= ValueTypedLocation(X) and
ValueTypedLocation(X) <= (x + SD)
    and (y − SD) <= ValueTypedLocation(Y) and
ValueTypedLocation(Y) <= (y + SD) Then
    TotalFieldsFound = TotalFieldsFound + 1
    EndIf
                End For
            End For
        End For
    End For
        If (TotalFieldsFound / NumOverlays) =
    Round(NumValuesTyped / NumOverlays) Then End
Else Continue
End For
```

According to another example embodiment, a process to assign a typed value to a field may include:

```
For FieldNumber = 1 to NumFieldsActual
    For x = 0 to Xmax
        For y = 0 to Ymax
            For Overlay = 1 to NumOverlays
            For ValueTyped = 1 to MaxOnOverlay
                If (x − SD) <= ValueTypedLocation(X)
            and ValueTypedLocation(X) <= (x + SD)
            and (y − SD) <= ValueTypedLocation(Y) and
        ValueTypedLocation(Y) <= (y + SD) Then
            Field(Overlay,FieldNumber) = ValueTyped
                EndIf
            End For
        End For
    End For
End For
```

According to another example embodiment, a process to assign a coordinate to a field in an overlay is shown below. This process occurs only once for an overlay. Once the coordinate is assigned to a field a text box can be placed at that location. The process includes:

For FieldNumber=1 to NumFieldsActual
Xsum=(Value of X coordinate for Field Number)+Xsum

(Note: this could be Defined Better.)
Ysum=(Value of Y coordinate for Field Number)+Ysum
Xaverage=Xsum/NumFieldsActual
Yaverage=Ysum/NumFieldsActual
Xcoordinate of textbox=Xaverage
Ycoordinate of textbox=Yaverage.

According to another example embodiment, a process that compares the coordinates of the text in the form with coordinates of the text box may also be included. The text in the form closest to the text box is used as the field name. The data validation is looked-up in a reference table based on the name of the field. In another example, a text box may be placed directly in the form instead. The process to calculate the distance between coordinates may compare the straight line distance of the two coordinates with the sensitivity distance calculated as a radius in any direction from the first coordinate forming a circular search area and measured from the (x,y) coordinate. These processes are not limited to text boxes but can also work on radio buttons, check boxes, and similar data entry devices. These processes describe one page of a form. There is one overlay for each page of a form. In practice some forms may have multiple pages, in which case these processes apply to each page of the form and there will be more than one overlay per form.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

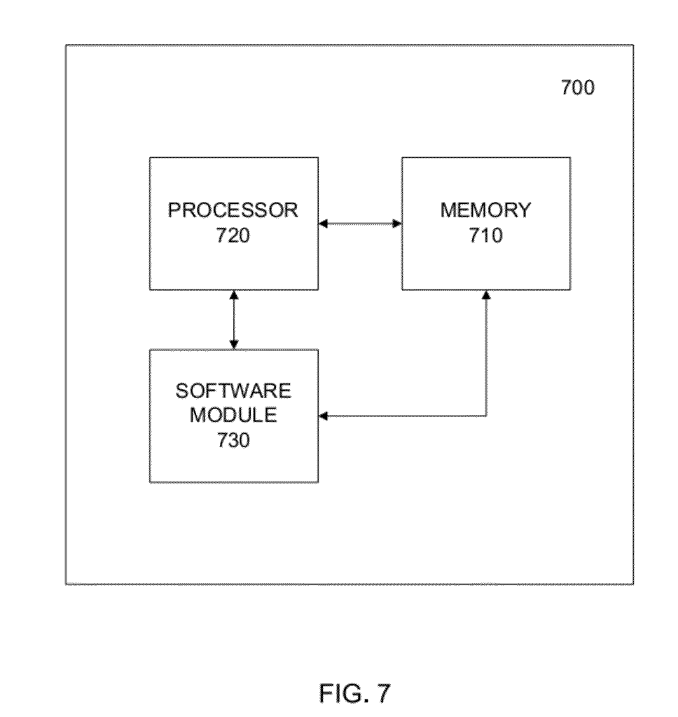

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 7 illustrates an example network element 700, which may represent any of the above-described network components of the other figures.

As illustrated in FIG. 7, a memory 710 and a processor 720 may be discrete components of the network entity 700 that are used to execute an application or set of operations. The application may be coded in software in a computer language understood by the processor 720, and stored in a computer readable medium, such as, the memory 710. Furthermore, a software module 730 may be another discrete entity that is part of the network entity 700, and which contains software instructions that may be executed by the processor 720. In addition to the above noted components of the network entity 700, the network entity 700 may also have a transmitter and receiver pair configured to receive and transmit communication signals (not shown).

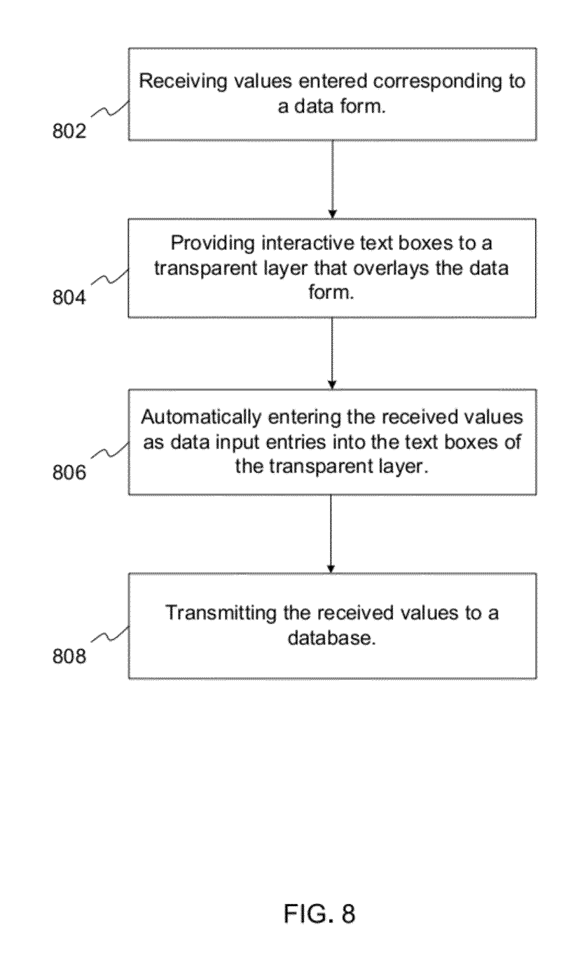

One example embodiment of the present invention may include a method as illustrated in the flow diagram of FIG. 8. Referring to FIG. 8, the method may provides receiving values entered corresponding to a data form, at operation 802 and providing interactive text boxes to a transparent layer that overlays the data form, at operation 804. The method may also include automatically entering the received values as data input entries into the text boxes of the transparent layer, at operation 806 and transmitting the received values to a database at operation 808.

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method, comprising:
receiving values entered corresponding to a data form;
providing interactive text boxes to a transparent layer that overlays the data form;
automatically entering the received values as data input entries into the text boxes of the transparent layer; and
transmitting the received values to a database.

2. The method of claim 1, wherein the data form is displayed on a user monitor device and the transparent layer is not viewable to a user of the user monitor device.

3. The method of claim 1, further comprising:
adding new data fields to a file stored in the database and naming the new data fields based on the coordinates of the received values positions with respect to the position of the data form.

4. The method of claim 1, further comprising:
creating an additional transparent overlay when a new user begins accessing the data form.

5. The method of claim 1, further comprising:
retrieving data values that were previously stored in the database; and
automatically entering the retrieved data values into the text boxes.

6. The method of claim 1, further comprising:
saving and storing the data form as a first data file in the database; and
saving and storing the data values as a second data file in the database.

7. The method of claim 1, further comprising:
exporting each of the received values to a spreadsheet file stored in the database.

8. An apparatus, comprising:
a receiver configured to receive values entered corresponding to a data form;
a processor configured to provide interactive text boxes to a transparent layer that overlays the data form and automatically enter the received values as data input entries into the text boxes of the transparent layer; and
a transmitter configured to transmit the received values to a database.

9. The apparatus of claim 8, wherein the data form is displayed on a user monitor device and the transparent layer is not viewable to a user of the user monitor device.

10. The apparatus of claim 8, wherein the processor is further configured to add new data fields to a file stored in the database and name the new data fields based on the coordinates of the received values positions with respect to the position of the data form.

11. The apparatus of claim 8, wherein the processor is further configured to create an additional transparent overlay when a new user begins accessing the data form.

12. The apparatus of claim 8, wherein the processor is further configured to retrieve data values that were previously stored in the database, and automatically enter the retrieved data values into the text boxes.

13. The apparatus of claim 8, wherein the processor is further configured to save and store the data form as a first data file in the database save and store the data values as a second data file in the database.

14. The apparatus of claim 8, wherein the processor is further configured to export each of the received values to a spreadsheet file stored in the database.

15. A non-transitory computer readable storage medium configured to store instruction that when executed cause a processor to perform:
receiving values entered corresponding to a data form;
providing interactive text boxes to a transparent layer that overlays the data form;
automatically entering the received values as data input entries into the text boxes of the transparent layer;
transmitting the received values to a database; and
storing the received values in the database.

16. The non-transitory computer readable storage medium of claim 15, wherein the data form is displayed on a user monitor device and the transparent layer is not viewable to a user of the user monitor device.

17. The non-transitory computer readable storage medium of claim 15, wherein the processor is further configured to perform:
adding new data fields to a file stored in the database and naming the new data fields based on the coordinates of the received values positions with respect to the position of the data form.

18. The non-transitory computer readable storage medium of claim 15, wherein the processor is further configured to perform:
creating an additional transparent overlay when a new user begins accessing the data form.

19. The non-transitory computer readable storage medium of claim 15, wherein the processor is further configured to perform:
retrieving data values that were previously stored in the database; and
automatically entering the retrieved data values into the text boxes.

20. The non-transitory computer readable storage medium of claim 15, wherein the processor is further configured to perform:
saving and storing the data form as a first data file in the database; and
saving and storing the data values as a second data file in the database.
